(19) United States
(12) Patent Application Publication
(10) Pub. No.: US 2009/0034762 A1
(43) Pub. Date: Feb. 5, 2009

(54) ARRAY SPEAKER DEVICE

(75) Inventors: Yusuke Konagai, Hamamatsu-shi (JP); Kenichiro Takeshita, Hamamatsu-shi (JP)

Correspondence Address: ROSSI, KIMMS & McDOWELL LLP., 20609 Gordon Park Square, Suite 150, Ashburn, VA, 20147, US

(73) Assignee: YAMAHA CORPORATION, Hamamatsu-shi, Shizuoka-ken (JP)

(21) Appl. No.: 11/816,766

(22) PCT Filed: Jun. 1, 2006
(86) PCT No.: PCT/JP2006/311003

§ 371 Date: Aug. 21, 2007

(30) Foreign Application Priority Data
Jun. 2, 2005 (JP) 2005-162482

(51) Int. Cl. H04R 5/02

(52) U.S. Cl. 381/300

(57) ABSTRACT

In an array speaker device, a plurality of speaker units output sounds having directivities, which are then reflected on a prescribed wall or a reflection board so as to form virtual speakers, wherein a digital signal processor independently drives the plurality of speaker units in such a way that sound beams produced in response to input audio signals are emitted toward prescribed focal point positions in the space. A CPU sets up the focal point positions, which normally vibrate as necessary. Thus, a broad listening range and sound localization are realized.

### TECHNICAL FIELD

The present invention relates to array speaker devices in which sounds emitted from plural speaker units are reflected on walls or reflection boards so as to produce virtual sound sources at prescribed positions in three-dimensional space.

The present application claims priority on Japanese Patent Application No. 2005-162482 filed on Jun. 2, 2005, the content of which is incorporated herein by reference.

### BACKGROUND ART

Conventionally, array speaker devices in which plural speaker units are aligned one-dimensionally or two-dimensionally have been developed, wherein they are each designed such that desired directivities are applied to audio signals so as to localize virtual sound sources in three-dimensional space. For example, patent document 1 teaches an example of the technology for applying a desired directivity to audio signals.

Patent document 1: International Publication No. WO01/23104

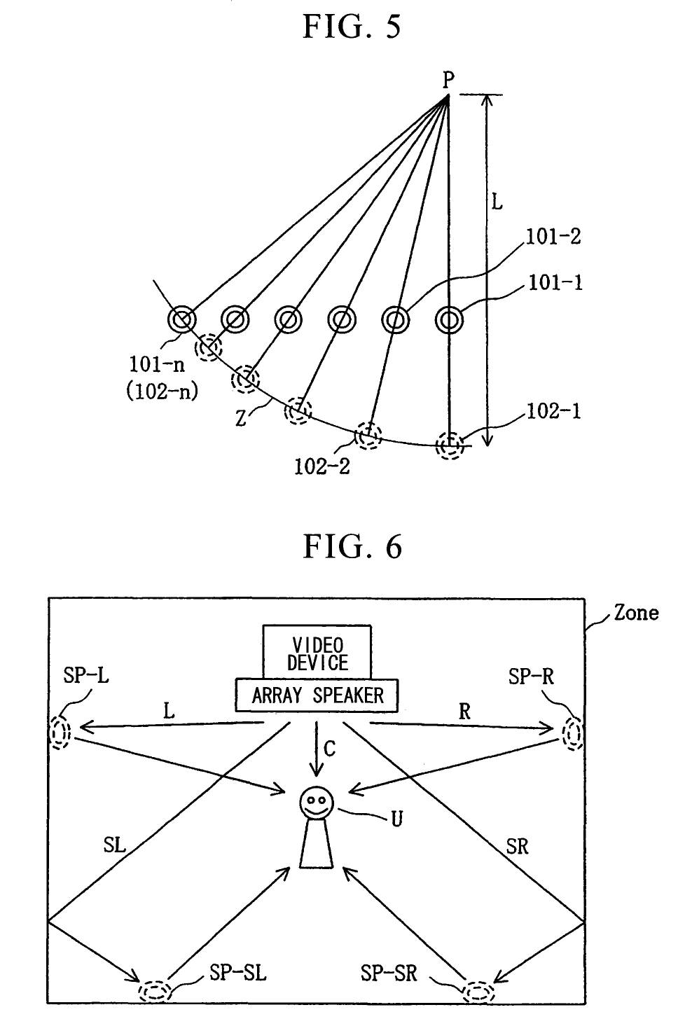

The operating principle of an array speaker device will be described with reference to FIG. 5. A plurality of speakers 101-1 to 101-n one-dimensionally aligned and an arbitrary focal point P are defined. Herein, a circular arc Z positioned with a distance L from the focal point P is drawn, so that line segments connecting between the focal point P and plural speakers 101-1 to 101-n are extended to cross the circular arc Z at intersecting points, at which virtual speakers 102-1 to 102-n (designated by dotted circles) are defined. All of the virtual speakers 102-1 to 102-n are arranged with the same distance L from the focal point P; hence, sounds emitted from the virtual speakers 102-1 to 102-n reach the focal point P at the same time.

When sound emitted from the speakers 101-i (where i=1, 2, . . . , n) that are actually aligned reaches the focal point P at the same time, it is necessary to apply delay times (or time differences), which correspond to distances between the speakers 101-i and the corresponding virtual speakers 102-i, to emitted sound of the speakers 101-i. That is, sound control is performed such that the virtual speakers 102-1 to 102-n are arranged on the circular arc Z in view of the focal point P. Thus, all of sound output from the speakers 101-1 to 101-n have the same phase at the focal point P, thus forming a peak in sound-pressure distribution. As a result, it is possible to produce sound pressure distribution having a prescribed directivity in which an array speaker device having plural speakers emits a sound beam toward the focal point P.

When speakers are aligned two-dimensionally in an array speaker device, it is possible to output a sound beam having a three-dimensional directivity. In addition, the array speaker device has characteristics in which different directivities are applied to plural audio signals, which are then subjected to convolution and emission, thus making it possible to simultaneously output sound beams of plural channels.

Therefore, as shown in FIG. 6, it is possible for a single array speaker device to form a 5-channel audio surround system. In FIG. 6, reference symbol Zone designates a listening room for performing audio surround reproduction; reference symbol U designates a listening position; reference symbol SP-L designates a left-channel virtual main speaker formed on a left wall; reference symbol SP-R designates a right-channel virtual main speaker formed on a right wall; reference symbol SP-SL designates a left-channel virtual rear speaker formed on a rear wall; and reference symbol SP-SR designates a right-channel virtual rear speaker formed on the rear wall.

In FIG. 6, a center signal is emitted from the center position of the array speaker device to the listening position U; directivity is applied to a left-channel main signal (L) and a right-channel main signal (R), which are then emitted toward the left and right walls; directivity is applied to a left-channel rear signal (SL) and a right-channel rear signal (SR), which are then emitted toward the rear wall distanced from the listening position U, thus realizing an audio surround system. This audio surround system can localize a virtual speaker at a prescribed position by use of a single array speaker device, thus providing various advantages. A first advantage is that a single array speaker device is arranged singly, hence, it is unnecessary to physically arrange plural speakers and to establish wiring therebetween. A second advantage is that distances of paths from the speakers to the listener are increased so that the listener can experience spread sound. A third advantage is that each virtual speaker is localized but intangible; hence, the listener can experience a sound field different from the sound field produced by an actual speaker physically arranged by the listener; hence, it is possible for the listener to experience a natural and uniform sound field.

However, the audio surround system using the array speaker device has the following problems.

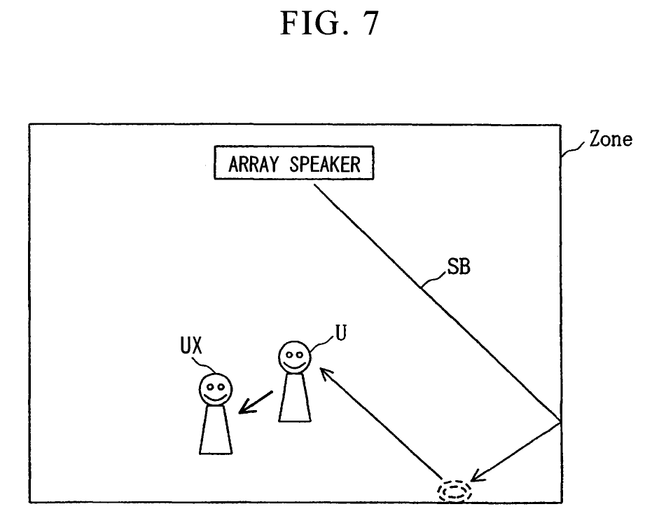

First, a sound beam lies in a linear path, so that it is reflected on a wall with an incident angle and an outgoing angle, which are identical to each other; hence, the sound beam can be easily controlled to be emitted in a target direction. However, it is very difficult to provide the sound beam to a prescribed position in a broad range of space. For example, as shown in FIG. 7, energy of a sound beam is concentrated at the center of directivity shown by a straight line SB; hence, the listener is capable of recognizing localization of a virtual speaker at the listening position U; however, when the listening position moves to UX, sound energy decreases so that the listener cannot recognize localization of a virtual speaker.

Second, in the audio surround system using a single array speaker, realistically, it is difficult to realize a desired directivity in a broad range of frequencies ranging from a low band to a high band. Even when flat frequency characteristics are realized at the center of the straight line SB, frequency characteristics are greatly changed when departing from the center.

In order to broaden the listening range, it may be necessary to thicken the sound beam, i.e., it may be necessary to slightly weaken the directivity; however, thickening the sound beam results in weakening the concentration of sound energy; this makes it difficult for the listener to recognize sound-image positioning (sound localization). That is, there is an antinomy relationship between the listening range and the sound localization. In the audio rear surround system shown in FIG. 7, a directivity lying along the straight line SB is applied to a sound beam, which is then reflected on a side wall and a rear wall twice in total so as to reach the listening position U; therefore, the propagation distance of the sound beam therebetween forms an important factor. At a long distance from the listening position U, sound energy greatly decays; hence, in order to realize desired sound localization, sound must be concentrated with high energy; for this reason, it is difficult to secure a broad listening range.

### DISCLOSURE OF INVENTION

### Problem to be Solved by the Invention

It is an object of the present invention to provide an array speaker device that can realize a desired sound localization in a broad listening range.

### Means of Solving the Problem

In a first aspect of the present invention, an array speaker device, in which sounds having directivities output from a plurality of speaker units are reflected on a prescribed wall or a reflection board so as to form virtual speakers, includes a directivity control means for independently driving the plurality of speaker units so that sound beams, which are generated in response to input audio signals, are emitted toward prescribed focal points in the space, and a setup means for setting up focal point positions, wherein the setup means continuously vibrates the focal point positions.

In a second aspect of the present invention, in the aforementioned array speaker device, the setup means sets up shapes and directivity intensities of sound beams emitted from the plurality of speaker units, thus realizing an effect in which sound beams continuously vibrate in thickness.

It is possible for the aforementioned setup means to change the focal point positions with time intervals suiting 1/f fluctuations, or it is possible to change the shapes and directivity intensities of sound beams with time intervals suiting 1/f fluctuations.

When multi-channel audio signals are input as input audio signals, the directivity control means applies delay times corresponding to focal point positions to multi-channel audio signals, which are then added together so as to drive the plurality of speaker units; and the setup means sets up focal point positions with respect to multi-channel audio signals, whereby focal point positions normally vibrate with respect to specific audio signals within multi-channel audio signals. Alternatively, the setup means sets up shapes and directivity intensities of sound beams generated with respect to multi-channel audio signals, whereby shapes and directivity intensities of sound beams are changed with respect to specific audio signals within multi-channel audio signals, so that sound beams continuously vibrate in thickness.

### Effect of the Invention

In the array speaker device of the present invention, it is possible to realize a broad listening range and sound localization by continuously vibrating focal point positions; and the listener at the fixed listening position is capable of experiencing an auditory effect such that the size of a virtual speaker is broadened; hence, it is possible to produce a natural sound field. Alternatively, by normally vibrating shapes and directivity intensities of sound beams (or thickness of sound beams), it is possible to demonstrate similar effects. In this case, it is possible to make sound-field variations naturally by varying focal point positions or the thickness of sound beams with time intervals suiting 1/f fluctuations. In the processing of multi-channel audio signals, it is possible to realize an audio surround system by use of a single array speaker device. When focal point positions or the thickness of sound beams vibrate with respect to specific audio signals within multi-channel audio signals, e.g., rear surround channel audio signals in which the concentration of sound energy is an important factor, it is possible to realize sound localization and a broad listening range with respect to rear surround channels.

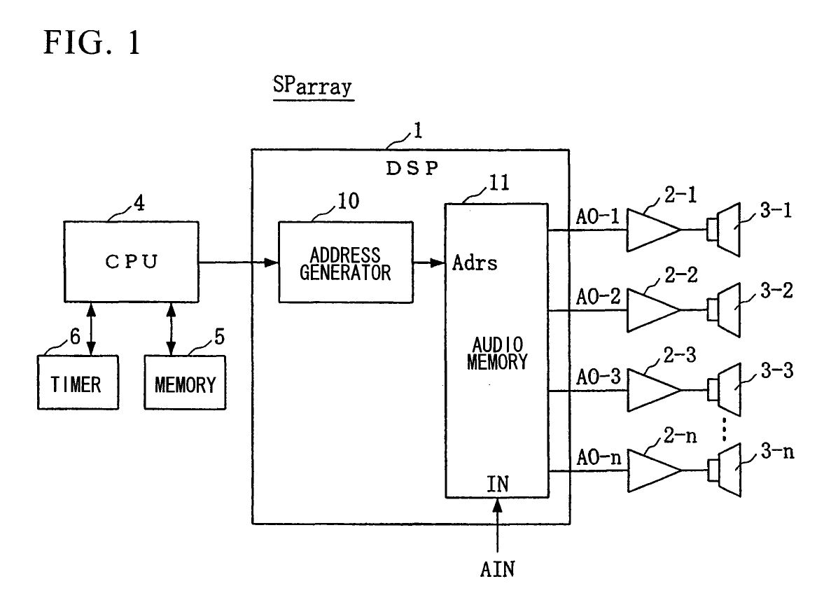

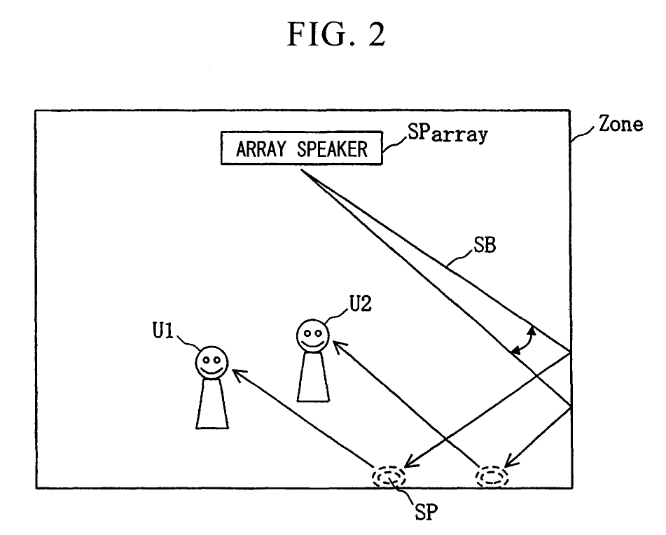

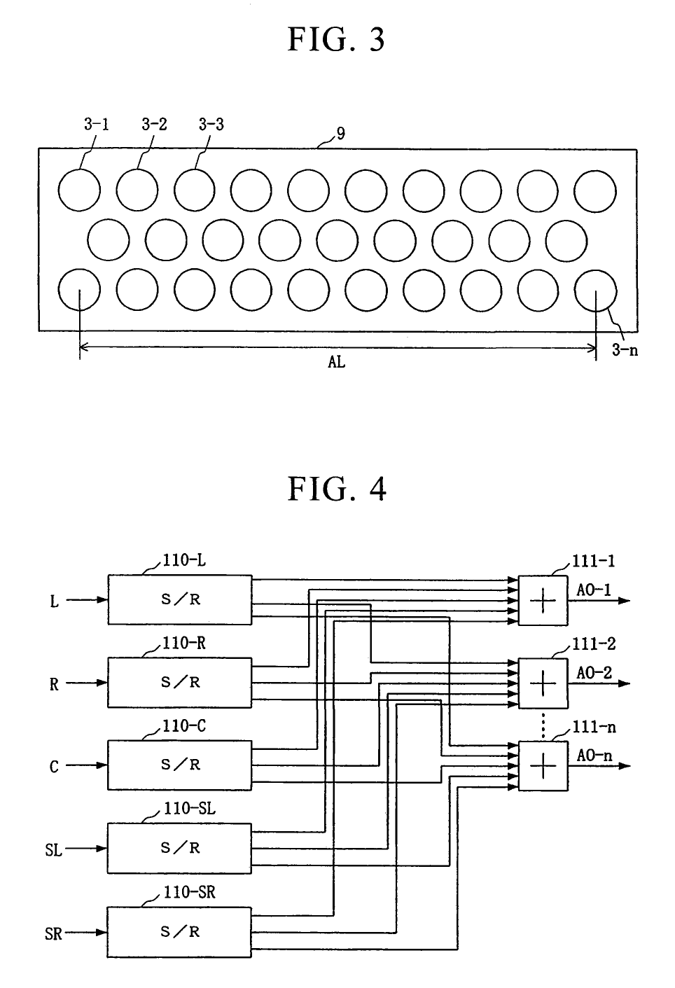

### BRIEF DESCRIPTION OF THE DRAWINGS

[FIG. 1] A block diagram showing the constitution of an array speaker device in accordance with a preferred embodiment of the present invention.

[FIG. 2] A figure for explaining variations of paths of sound beams emitted from the array speaker device shown in FIG. 1.

[FIG. 3] A figure diagrammatically showing an array speaker device, which is constituted of a plurality of speaker units arranged two-dimensionally on a baffle board.

[FIG. 4] A block diagram showing the processing with respect to multi-channel audio signals.

[FIG. 5] A figure for explaining the operation of the array speaker device.

[FIG. 6] A figure showing sound distribution of an audio surround system realized using a single array speaker device.

[FIG. 7] A figure for explaining a problem of the audio surround system realized using the single array speaker device.

### DESCRIPTION OF THE REFERENCE NUMERALS

1 digital signal processor (DSP)
2 amplifier
3 speaker unit
4 CPU
5 memory
6 timer
9 baffle board
10 address generator
11 audio memory
110 shift register
111 adder

### BEST MODE FOR CARRYING OUT THE INVENTION

The preferred embodiment of the present invention will be described in detail with reference to the accompanying drawings.

FIG. 1 is a block diagram showing the constitution of an array speaker device SParray in accordance with an embodiment of the present invention. The array speaker device SParray includes a digital signal processor (DSP) 1 for applying delay times corresponding to directivities realized on input audio signals, amplifiers 2 (i.e., 2-1 to 2-n) for amplifying audio signals output from the DSP 1, speaker units 3 (i.e., 3-1 to 3-n) driven by the amplifiers 2, a CPU 4 for setting the delay times of the DSP 1, a memory 5 for storing programs executed by the CPU 4 and a predetermined focal point position, and a timer 6 for outputting time information to the CPU 4. The DSP 1 forms a directivity control means; the CPU 4, the memory 5, and the timer 6 form a setup means.

The plural speaker units 3-1 to 3-n are arranged one-dimensionally or two-dimensionally on a baffle board (not shown).

An audio signal AIN is input to an audio input terminal IN of the DSP 1, in which it is applied with delay times to form audio signals AO-1 to AO-n for use in the speaker units 2-1 to 2-n. Herein, the audio signals AO-i applied with prescribed delay times by the DSP 1 are supplied to the amplifiers 2-i (i=1, 2, . . . , n), so that the speaker units 3-i emit sounds correspondingly, wherein the delay times are adjusted in such a way that sounds are emitted toward a prescribed focal point set in the space.

In FIG. 1, the DSP 1 includes an address generator 10 and an audio memory 11. The audio memory 11 serves as a shift register for applying prescribed delay times to the input audio signal AIN, wherein by appropriately selecting tap positions output for the plural amplifiers 2-1 to 2-n, the prescribed delay times are applied to the audio signals AO-1 to AO-n output from the amplifiers 2-1 to 2-n. The tap positions are each selected in response to an address supplied to an address terminal Adrs from the address generator 10.

The CPU 4 calculates delay times applied to the audio signals AO-1 to AO-n output from the plural amplifier 2-1 to 2-n. That is, the CPU 4 calculates an address of taps (i.e., delay times) of the DSP 1 in such a way that sounds emitted from the plural speaker units 3-1 to 3-n simultaneously reach a prescribed focal point in the space, so that the address generator 10 generates the address, thus applying desired delays. The taps of the DSP 1 can be directly determined based on spatial coordinates of the speaker units 3-1 to 3-n and spatial coordinates of a focal point. The spatial coordinates of the speaker units 3-1 to 3-n are physically determined, while the spatial coordinates of the focal point are set based on a preset value stored in the memory 5 and a value input by a user.

The amplifiers 2-1 to 2-n amplifies the audio signals AO-1 to AO-n output from the DSP 1 so as to drive the speaker units 3-1 to 3-n. Thus, sounds are emitted toward the focal point in the space.

In the aforementioned array speaker device, the CPU 4 sets up such that the focal point position normally vibrates within a small range of distance. The CPU 4 calculates plural sets of taps based on plural focal point positions, so that one set is sequentially selected from among the plural sets and is then set to the DSP 1. This operation is repeated to realize execution, wherein the taps are each changed with a certain time interval in synchronization with time counted by the timer 6.

When the focal point position vibrates, a sound beam SB emitted from the array speaker device SParray passes through different focal points at different times so as to reach different listening positions. That is, as shown in FIG. 2, the path of the sound beam SB varies with respect to time; hence, the optimum listening position varies correspondingly. The optimum listening position is set to the position designated by U1 at a certain time, while the optimum listening position is set to the position designated by U2 at another time. Thus, the present embodiment can offer an effect in which plural sound beams are output, wherein it is possible for the listener to listen to the sound beam propagated with the optimum path at plural listening positions; hence, it is possible to realize a broad listening range without degrading sound localization.

When the listener is fixed at one position, the listener may feel as if the virtual speaker SP formed on the wall of the listening room Zone moves in a short period of time; as a result, it is possible to offer an auditory effect in which the area of forming the virtual speaker SP is broadened. In other words, the virtual speaker SP is not artificially localized at one position, but it is possible to form an entirely natural sound field.

The aforementioned movement of the focal point can be realized by changing an emission angle of the sound beam in a horizontal direction (i.e., left-right directions in FIG. 2), by changing an emission angle in a vertical direction (i.e., a direction perpendicular to the sheet of FIG. 2), and by changing the focal length. FIG. 2 shows that the emission angle of the sound beam is changed in the horizontal direction. Changing the emission angle of the sound beam in the horizontal direction is effective in order to enlarge the listening range in a plane. Changing the emission angle of the sound beam in the vertical direction does not contribute to the enlargement of the listening range; however, in terms of psychoacoustics, it is possible to offer an effect in which the localized position of the virtual speaker is not limited.

The focal length from the array speaker device SParray to the focal point forms a parameter for determining the shape of the sound beam, i.e., the directivity intensity. As the focal length becomes short, the degree of directivity becomes dull; as the focal length becomes long, the degree of directivity becomes keen. The degree of directivity forms a parameter regarding the sound localization and listening range, which is in a antinomy relationship; hence, it is possible to enlarged the listening range by normally moving the focal point and by changing the focal length.

Another factor for determining the shape of the sound beam, i.e., the degree of directivity, is a width AL of the array speaker device shown in FIG. 3. As shown in FIG. 3, the plural speaker units 3-1 to 3-n are two-dimensionally arranged on a baffle board 9. As the width AL of the array speaker device becomes large, the degree of directivity becomes keen. Incidentally, it is unnecessary to actually change the width AL of the array speaker device; for example, it is possible to apparently change the width AL of the array speaker device by introducing a window function or digital filtering; in that case, it is possible to offer an effect identical to the effect for changing the focal length. Alternatively, it is possible to apparently change the width AL of the array speaker device when the DSP 1 changes gains of audio signals supplied to the speaker units positioned in the peripheral portion of the array speaker device under control of the CPU 4.

It is preferable that the movement of the focal point position be realized using a time constant, which does not cause the listener to feel discomfort in audio. That is, it is possible to prevent the listener from feeling discomfort in audio when the focal point position is changed with time intervals corresponding to units of seconds suiting a release time in general sound processing. This does not necessarily employ a fixed time interval; that is, it is possible to naturally change the focal point position by changing the focal point position with time intervals suiting 1/f fluctuations.

For the sake of simplification, FIG. 1 and FIG. 2 show a 1-channel audio signal processing; however, in the actual audio surround system, the DSP 1 processes multi-channel audio signals. FIG. 4 is a block diagram diagrammatically showing the processing of the DSP 1 with respect to multi-channel audio signals.

Plural shift registers (S/R) (identical to the audio memory of FIG. 1) are arranged with respect to multi-channel audio signals, wherein a left-channel shift register 110-L generates n left-channel main signals (L), to which delay times are applied so that a sound beam is emitted toward a prescribed focal point; similarly, a right-channel shift register 110-R generates n right-channel main signals (R); a center-channel shift register 110-C generates n center-channel signals (C); a left-channel rear shift register 110-SL generates n left-channel rear signals (SL); and a right-channel rear shift register 110-SR generates n right-channel rear signals (SR). The CPU 4 independently sets up the focal point positions in correspondence with the aforementioned signals L, R, C, SL, and SR.

There are arranged n adders 111-1 to 111-n for adding the signals. That is, the adder 111-1 adds the signals L, R, C, SL, and SR for use in the speaker unit 3-1, which are output from the shift registers 110-L, 110-R, 110-C, 110-SL, and 110-SR, thus supplying added signals to the amplifier 2-1. Similarly, the adder 111-2 adds the signals L, R, C, SL, and SR for use in the speaker unit 3-2, thus supplying added signals to the amplifier 2-2; and the adder 111-n adds the signals L, R, C, SL, and SR for use in the speaker unit 3-n, thus supplying added signals to the amplifier 2-n. Thus, it is possible to realize the 5-channel audio surround system shown in FIG. 6.

Similar to the 1-channel audio signal processing shown in FIG. 1 and FIG. 2, the CPU 4 normally vibrates the focal point positions corresponding to the signals L, R, C, SL, and SR within a small range of distance. Thus, it is possible to offer an effect in which the localization of multi-channel virtual speakers is not limited in terms of psychoacoustics. That is, it is possible to form a natural and integrally connected high quality sound field without having the listener notice distances between plural virtual speakers.

The aforementioned effect effectively works with respect to rear surround channels (i.e., rear signals SL, SR), in which concentration of sound energy forms an important factor; hence, it is possible to redesign such that the focal point positions normally vibrate with respect to the rear signals only.

### INDUSTRIAL APPLICABILITY

The present invention is applicable to a multi-channel audio surround system using an array speaker device.

1. An array speaker device in which a plurality of speaker units output sounds having directivities, which are then reflected on a wall or a reflection board so as to form virtual speakers, said array speaker device comprising:
a directivity control means for independently driving the plurality of speaker units in such a way that sound beams produced in response to input audio signals are emitted toward prescribed focal points in a space; and
a setup means for setting up focal point positions,
wherein the setup means normally vibrates the focal point positions.

2. An array speaker device in which a plurality of speaker units output sounds having directivities, which are then reflected on a wall or a reflection board so as to form virtual speakers, said array speaker device comprising:
a directivity control means for independently driving the plurality of speaker units in such a way that sound beams produced in response to input audio signals are emitted toward prescribed focal points in a space; and
a setup means for setting up shapes and degrees of directivity of the sound beams emitted from the plurality of speaker units,
wherein the setup means realizes an effect in which the sound beams continuously vibrate in thickness.

3. The array speaker device according to claim 1, wherein the setup means changes the focal point position with time intervals suiting 1/f fluctuations.

4. The array speaker device according to claim 2, wherein the setup means changes the shapes and degrees of directivity of the sound beams with time intervals suiting 1/f fluctuations.

5. The array speaker device according to claim 1 or 3, wherein multi-channel audio signals are input as the input audio signals,
wherein the directivity control means applies delay times to the multi-channel audio signals in response to the focal point positions, so that the multi-channel audio signals are added together so as to drive the plurality of speaker units, and
wherein the setup means sets up the focal point positions with respect to the multi-channel audio signals, so that the focal point positions normally vibrate with respect to specific audio signals within the multi-channel audio signals.

6. The array speaker device according to claim 2 or 4, wherein multi-channel audio signals are input as the input audio signals,
wherein the directivity control means applies delay times to the multi-channel audio signals with respect to the focal point positions, so that the multi-channel audio signals are added together so as to drive the plurality of speaker units, and
wherein the setup means sets up the shapes and degrees of directivity of the sound beams produced with respect to the multi-channel audio signals, so that the shapes and degrees of directivity of the sound beams are changed with respect to specific signals within the multi-channel audio signals, thus normally vibrating the sound beams in thickness.
